(19) United States
(12) Patent Application Publication
(10) Pub. No.: US 2021/0224747 A1
(43) Pub. Date: Jul. 22, 2021

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventor: Yasuhiro ITO, Kanagawa (JP)

(73) Assignee: FUJI XEROX CO., LTD., Tokyo (JP)

(21) Appl. No.: 16/939,052

(22) Filed: Jul. 26, 2020

(30) Foreign Application Priority Data
Jan. 22, 2020 (JP) 2020-008031

(51) Int. Cl. G06Q 10/10; G06Q 50/18; G06N 3/08; G06Q 50/00

(52) U.S. Cl. CPC G06Q 10/10; G06Q 50/01; G06N 3/08; G06Q 50/18

(57) ABSTRACT

An information processing apparatus includes a processor configured to acquire an amendment point of a law, acquire internal information of a group, which is influenced by amendment of the law, acquire external information related to the amendment of the law from pieces of the external information provided outside the group, and acquire determination result information regarding necessity of a change in response to the amendment of the law for each piece of the internal information by inputting the amendment point of the law, the internal information, and the acquired external information, to a learning model learned by a combination of the external information acquired in response to the previous amendment of the law and the internal information of the group, which has been changed in response to the previous amendment of the law.

### CROSS-REFERENCE TO RELATED APPLICATIONS

This application is based on and claims priority under 35 USC 119 from Japanese Patent Application No. 2020-008031 filed Jan. 22, 2020.

### BACKGROUND

### (i) Technical Field

The present invention relates to an information processing apparatus and a non-transitory computer readable medium storing a program.

### (ii) Related Art

The laws will be appropriately amended by the influence of social conditions and precedents. The content of the amendment is expressed by adding or changing the provisions of the law.

For example, in JP2010-191657A, a technique as follows is proposed: it is possible to easily recognize the updated information, for example, by automatically acquiring the amendment of an ordinance, comparing the amended provision to the provision before the amendment, and performing a notification in a case where there is a difference in the provision.

JP2013-175170A and JP2015-052855A are examples in the related art.

### SUMMARY

In a case where a law is amended, it may be necessary to change internal information in response to the amendment of the law because the internal information in a group such as a company may include information (for example, in-house rules) related to the law. In a case where the internal information already corresponds to the amended law, it is considered that there is no need to change the internal information in response to the amendment of the law. Even in a case where the content of the internal information does not violate the amended law, it may be better to change the internal information under the influence of the amendment of the law.

Aspects of non-limiting embodiments of the present disclosure relate to an information processing apparatus and a non-transitory computer readable medium storing a program that obtain the necessity of changing internal information of a group, which is influenced by the amendment of a law.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to acquire an amendment point of a law, acquire internal information of a group, which is influenced by amendment of the law, acquire external information related to the amendment of the law from pieces of the external information provided outside the group, and acquire determination result information regarding necessity of a change in response to the amendment of the law for each piece of the internal information by inputting the amendment point of the law, the internal information, and the acquired external information, to a learning model learned by a combination of the external information acquired in response to the previous amendment of the law and the internal information of the group, which has been changed in response to the previous amendment of the law.

### BRIEF DESCRIPTION OF THE DRAWINGS

Exemplary embodiment(s) of the present invention will be described in detail based on the following figures, wherein:

FIG. 1 is an overall configuration diagram illustrating a network system including a company system according to an exemplary embodiment;

FIG. 2 is a flowchart illustrating change necessity determination processing in the exemplary embodiment;

FIG. 3 is a diagram illustrating an example of external information handled in the exemplary embodiment;

FIG. 4 is a diagram illustrating an example of a data format of input information input to a learning model in the exemplary embodiment;

FIG. 5 is a diagram illustrating an example of a data format of law amendment information input to the learning model in the exemplary embodiment;

FIG. 6 is a diagram illustrating an example of a data structure of determination result information in the exemplary embodiment;

FIG. 7 is a diagram illustrating another example of the data structure of the determination result information in the exemplary embodiment;

FIG. 8 is a diagram illustrating a display example in a case where the determination result information is displayed in a graph format in the exemplary embodiment;

FIG. 9 is a diagram illustrating still another example of the data structure of the determination result information in the exemplary embodiment;

FIG. 10 is a diagram illustrating another example of the handled external information and the input information in the exemplary embodiment; and

FIG. 11 is a diagram illustrating still another example of the external information handled in the exemplary embodiment.

### DETAILED DESCRIPTION

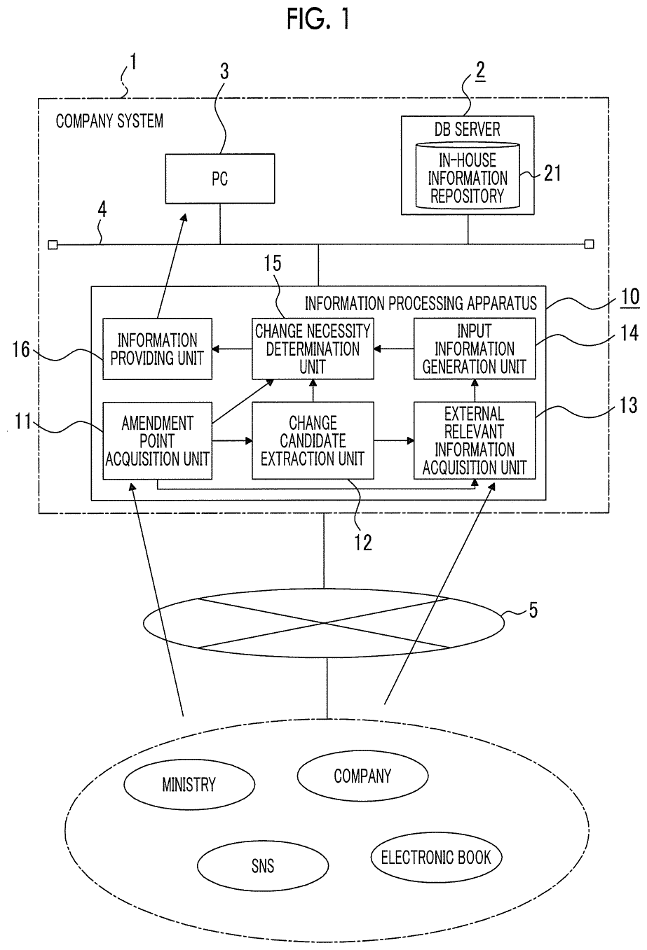

FIG. 1 is an overall configuration diagram-illustrating a network system including a company system according to an exemplary embodiment. FIG. 1 illustrates a block configuration of the company system together. FIG. 1 illustrates a company system 1 connected via the Internet 5 to an external system, for example, ministries, social networking service (referred to as an “SNS” below) systems, web access logs, systems of other companies, and a database server configured to accumulate electronic data (referred to as “electronic books” below) of magazines or publications of legal manuals, minutes, and the like. In the following description, the systems outside the company system 1 are collectively referred to as “outside”. Further, various types of information provided from the outside are collectively referred to as “external information”.

The company system 1 is a network system constructed in a certain company, and has a configuration in which an information processing apparatus 10, a database (DB) server 2, and a Personal Computer (PC) 3 are connected to a Local Area Network (LAN) 4. Illustrations of constituent components which are not used in the description in the exemplary embodiment are omitted in the drawings. In the following description, the term “company” simply refers to a company having the company system 1.

The database (DB) server 2 has an in-house information repository 21. In the in-house information repository 21, various types of internal information related to the company, which are digitized, for example, in-house rules and the organizational structure of the company, technical fields that companies are working on, information regarding techniques and products owned in each technical field, and technical information such as design documents and manuals are accumulated.

The PC 3 is a computer used by a company employee or the like, and may be realized with a general-purpose hardware configuration. That is, the PC 3 has a CPU, a ROM, a RAM, a storage unit, a communication interface, and a user interface.

The information processing apparatus 10 may be realized by a general-purpose computer such as a PC. Thus, the information processing apparatus 10 has a CPU, a ROM, a RAM, a storage unit, a communication interface, and a user interface.

The information processing apparatus 10 includes an amendment point acquisition unit 11, a change candidate extraction unit 12, an external relevant information acquisition unit 13, an input information generation unit 14, a change necessity determination unit 15, and an information providing unit 16. Illustrations of constituent components which are not used in the description in the exemplary embodiment are omitted in the drawings.

The amendment point acquisition unit 11 acquires an amendment point of a law by analyzing information provided from the outside. The change candidate extraction unit 12 extracts in-house information as a candidate for a change in response to the amendment of the law (referred to as “law amendment” below) from pieces of in-house information accumulated in the in-house information repository 21. The change candidate extraction unit performs the extraction with reference to information (“law amendment information” below) regarding the amendment point of the law. The external relevant information acquisition unit 13 acquires external information related to law amendment, from pieces of external information on the outside. In the exemplary embodiment, external information which is related to the law amendment and is selectively acquired from the outside by the external relevant information acquisition unit 13 is set to be particularly referred to as “external relevant information”. The input information generation unit 14 converts the external relevant information into a format causing the external relevant information to be easily processed by the change necessity determination unit 15.

The change necessity determination unit 15 determines the necessity of a change in response to the law amendment and acquires determination result information regarding the determination result, for each piece of in-house information extracted by the change candidate extraction unit 12. The change necessity determination unit 15 uses a learning model to determine the necessity of a change. The learning model is formed by being learned with a combination of the external relevant information acquired in response to the previous law amendment and the in-house information changed in response to the previous law amendment among pieces of information accumulated in the in-house information repository 21. According to an output example described later, the in-house information used for learning includes changed in-house rules and the like. The learning model receives, as an input, the amendment point of the law, the external relevant information acquired by the external relevant information acquisition unit 13, and the in-house information which has been extracted by the change candidate extraction unit 12 and serves as a candidate for a change. In the learning model, information indicating a determination result of the necessity of a change in response to the law amendment is output. The information providing unit 16 provides a user of the PC 3 or the like with the information obtained by the change necessity determination unit 15.

Each of the constituent components 11 to 16 in the information processing apparatus 10 is realized by a cooperative operation of a computer forming the information processing apparatus 10 and a program operated by a CPU mounted on the computer.

The program used in the exemplary embodiment may be provided not only by a communication unit, but also provided in a state of being stored in a computer readable recording medium such as a CD-ROM or a USB memory. The program provided from the communication unit or the recording medium is installed on the computer, and the CPU in the computer sequentially executes the program, and thereby various types of processing are realized.

As the measures of the company, it is required to comply with the law by changing the in-house information such as in-house rules or in-house documents, which is influenced by the law amendment. However, even in a case the measures to comply with the law are intended to be performed, the criticism that the company is not strict about the legal approach may be encountered from consumers. For example, consumers want to know information regarding the safety of products such as foods, but the company does not disclose the information because the information disclosure is not required by the law. In particular, in a case where another company discloses the information, the attitude of the company, that the company does not disclose the information, may damage the company image.

Considering such circumstances, the exemplary embodiment have been made to enable determination of the necessity to change in-house information influenced by the amendment of a law. In particular, in the exemplary embodiment, in a case where a law is amended, the necessity to change in-house information in a company in response to the law amendment is determined with reference to not only an amendment point of the law but also external information, strictly, external relevant information which is related to the law amendment among pieces of external information.

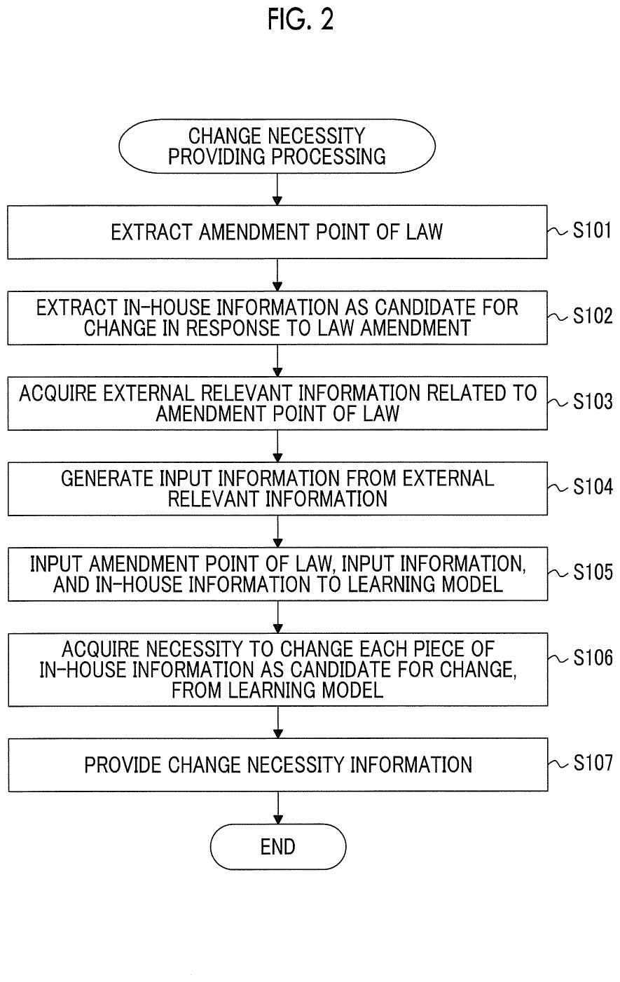

Next, processing of determining the necessity to change the in-house information and providing the determined information in the exemplary embodiment will be described with reference to the flowchart in FIG. 2.

In a case where a law is amended, the amendment point acquisition unit 11 acquires, from the outside, information regarding an amendment point of the law, that is, information indicating the amended part of the law (Step S101). For example, the homepage of a ministry or the like may be normally monitored, and thus the amendment point of the law may be acquired when the law amendment is detected. Alternatively, the amendment point of the law may be acquired by starting an operation at a timing at which an application of performing this processing is activated by a concerned person or the like in response to the law amendment. The law amendment information may be retained in a format of the information obtained from the outside. A difference between the provisions of the law before and after the amendment may be extracted, and the difference information may be retained as the law amendment information. The law amendment information may be retained in various formats without being limited to one format.

The change candidate extraction unit 12 extracts the in-house information as a candidate of a change from pieces of the in-house information accumulated in the in-house information repository 21, with reference to the law amendment information (Step S102). The in-house information as a change target is mostly in-house rules. In the exemplary embodiment, the description will be made using the in-house rules as an example, but it is not necessary to limit the in-house information to the in-house rules.

Then, the external relevant information acquisition unit 13 acquires external information related to the law amendment from pieces of external information provided on the outside, as external relevant information, with reference to the law amendment information (Step S103). For example, the external relevant information acquisition unit extracts a phrase related to the law amendment with reference to the law amendment information and acquires the external relevant information by search based on the extracted phrase. The external relevant information acquisition unit may select the external relevant information from pieces of external information derived from the acquired external information. The external information may be at least one of information (for example, a post to an SNS, a web access log, and pre-release) related to the amendment of the law, which is provided by the company, laws of other countries, electronic books, or information exchanged with related departments. The external relevant information acquisition unit 13 directly or indirectly acquires the external relevant information from the source of each type of information.

Then, the input information generation unit 14 generates input information to be input to the learning model, from the acquired external relevant information (Step S104). The external relevant information itself may be input to the learning model. However, since the external relevant information has various forms such as a message to be written to the SNS, articles, and papers, the input information generation unit 14 generates the input information by performing pre-processing of processing the above information to a format usable by the learning model, in other words, a format appropriate for being input to the learning model.

Then, the change necessity determination unit 15 inputs, to the learning model, the law amendment information acquired by the amendment point acquisition unit 11, the input information generated by the input information generation unit 14 based on the external relevant information, and the in-house information extracted by the change candidate extraction unit 12 (Step S105). The change necessity determination unit 15 acquires the information output from the learning model in response to the input of the information, that is, acquires determination result information indicating the determination result of the necessity to change the in-house information in response to the amendment of the law (Step S106).

In a case where the determination result information is acquired in this manner, the information providing unit 16 provides the information (Step S107). Although the destination of providing the information is assumed to be the PC 3, it is not limited to the PC 3 and the destination of providing the information may be the display of the information processing apparatus 10 or a storage unit such as the HDD. The information is not limited to being provided in the company system 1, and may be provided to the outside via the Internet 5.

The processing described above will be described with a specific example.

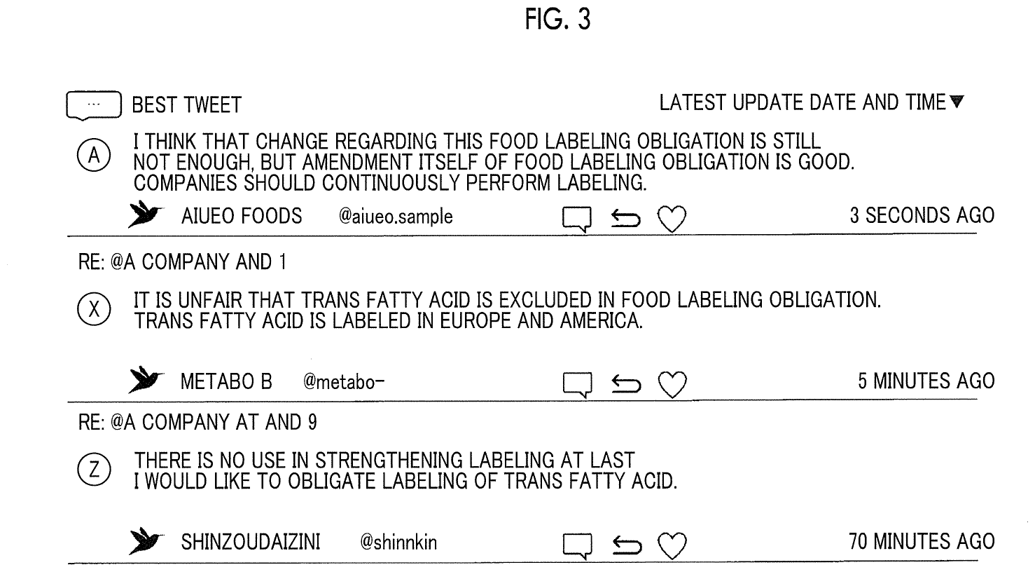

FIG. 3 is a diagram illustrating an example of external information handled in the exemplary embodiment. FIG. 3 illustrates a tweet posted as external information on Twitter (registered trademark). A “tweet” is a post on Twitter, also known as a “tweet”. Regarding the tweets, in a case of a phrase related to the law amendment, and the law amendment related to the labeling obligation of the Food Sanitation Law, phrases such as “Food Sanitation Law”, “labeling obligation”, “trans fatty acid”, and “vitamin C” as a change target of the law amendment are selected as keywords. In a case of the SNS as described above, the external relevant information acquisition unit 13 associates another piece of information on the outside by relevance of the contents or the like of a post, by analyzing the post to the SNS or the article, or analyzing a hash tag. Then, the external relevant information acquisition unit selects external information that is likely to be related to the law amendment and is set as an input target to the learning model, from pieces of external information and handles the selected external information as external relevant information.

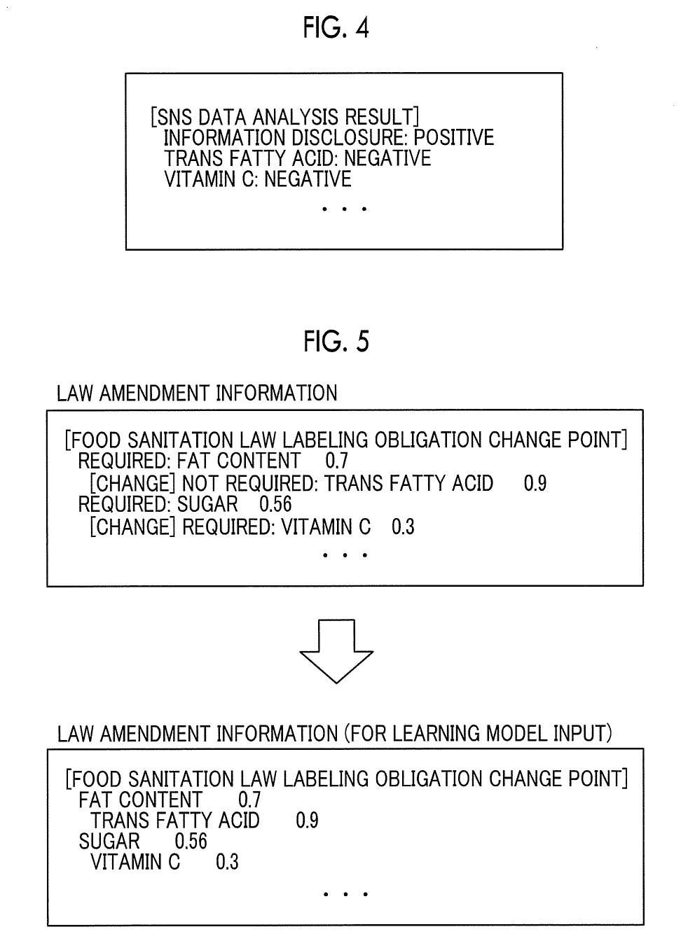

FIG. 4 is a diagram illustrating an example of a data format of the input information input to the learning model. As described above, various types of external information acquired as the external relevant information are provided. Thus, the format of the external information matches such that the learning model easily processes the external information. Therefore, the input information generation unit 14 generates information in the format illustrated in FIG. 4, as the input information. In FIG. 4, phrases extracted from the external relevant information and the impression for each word and phrase are set. In the exemplary embodiment, the external relevant information is analyzed, and thereby an impression of whether a post having a positive content for each phrase is posted or a post having a negative content for each phrase is posted is determined. Then, the determined impression is associated with the corresponding phrase.

FIG. 5 is a diagram illustrating an example of a data format of the law amendment information input to the learning model. The law amendment information includes components for the labeling obligation and components as a change target.

As described above, the learning model used by the change necessity determination unit 15 to determine the necessity of the change receives, as an input, the input information (FIG. 4) generated by the input information generation unit 14, the law amendment information (FIG. 5) acquired by the amendment point acquisition unit 11, and the in-house information extracted by the change candidate extraction unit 12. The learning model outputs the information indicating the determination result of the necessity to change the in-house information in response to the amendment of the law, that is, outputs the determination result information.

The determination result information output by the learning model includes the determination result of determining whether the change in response to the law amendment is required or not and the determination result indicating whether the change of the information is required after now, that is, in the future or may be not required. Each determination result is provided for each item included in the law amendment information. In a case of the example illustrated in FIG. 5, the determination result is obtained for each of components of fat content, trans fatty acid, sugar, and vitamin C. In the exemplary embodiment, the law amendment information is input to the learning model. However, because the determination result is output for each item, the change necessity determination unit 15 may input the items included in the law amendment information to the learning model one by one and repeat the input a number of times corresponding to the number of items.

The determination result information further indicates the determination result for each item for each piece of the in-house information which has been extracted by the change candidate extraction unit 12 and serves as a candidate for the change in response to the law amendment.

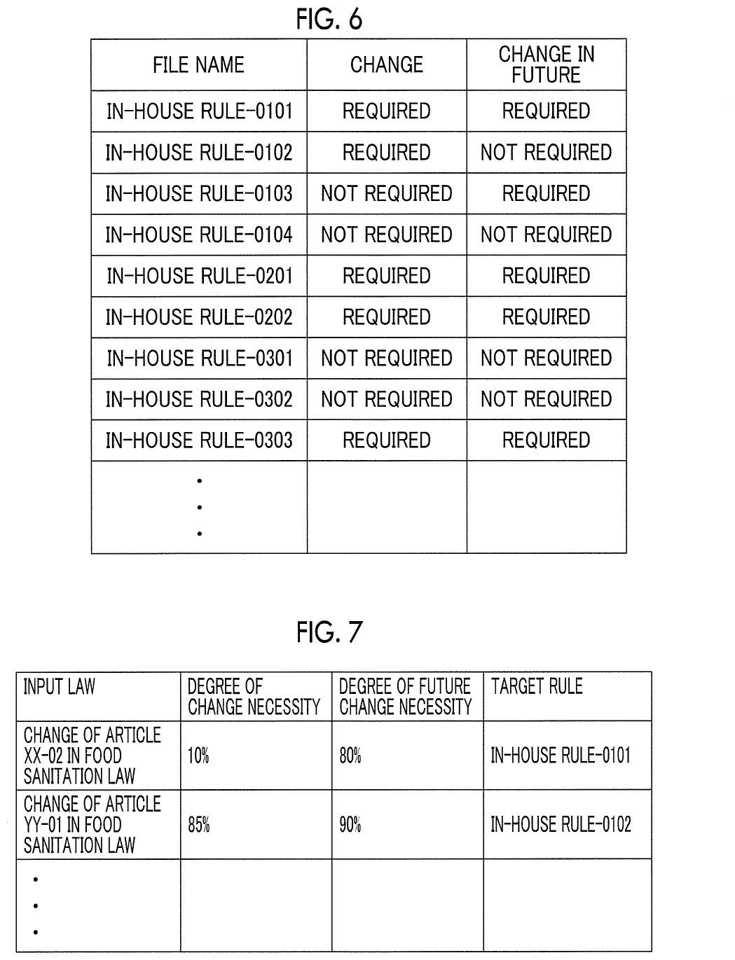

FIG. 6 is a diagram illustrating an example of a data structure of the determination result information in the exemplary embodiment. As described above, the determination result information illustrated in FIG. 6 is generated for each item (for example, trans fatty acid) included in the law amendment information. The determination result information indicates the determination result for each range of determination of the necessity of the change. FIG. 6 is an example in which the in-house information as the range of the change is illustrated for each file. A “file name” indicates a file of in-house information as a candidate for the change, and is information of identifying the in-house information selected by the change candidate extraction unit 12. A“change” indicates the necessity of the change at the current stage, as a determination result on the in-house information. A “change in the future” indicates, as a determination result, the necessity of the future change, differing from the change at the current stage. For example, in the file “In-house Rule-0101”, the determination results of the “change” and the “change in the future” are “required” together, and thus it is determined that the change is also required in the future. In the file “In-house Rule-0102”, as the determination results, the “change” is “required”, and the “change in the future” is “not required”. Thus, it is determined that the change is not required in the future. In the file “In-house Rule-0103”, as the determination results, the “change” is “not required”, and the “change in the future” is “required”. Thus, it is determined that the change is required in the future. In the file “In-house Rule-0104”, the determination results of the “change” and the “change in the future” are “not required” together, and thus it is determined that the change is required neither at the current stage nor in the future. That is, in “In-house Rule-0104”, the determination result that the influence of this law amendment is received neither at the current stage nor in the future.

FIG. 7 is a diagram illustrating another example of the data structure of the determination result information in the exemplary embodiment. FIG. 7 illustrates an example in which the necessity of the change at the current stage and the necessity of the change in the future are indicated by numerical values. FIG. 6 illustrates the example in which the numerical value indicating the necessity of the change output by the learning model is divided by a predetermined threshold value used for separating whether the change is required or not required, and the resultant is output. However, in FIG. 7 illustrates the example in which the determination result of the necessity, which is output by the learning model by a numerical value, itself is output. The output value itself of the learning model may be used, or the output value may be converted into a percentage and displayed as illustrated in FIG. 7. In addition, in the example illustrated in FIG. 7, the example in which the information providing unit 16 adds information (“input law” in FIG. 7) of identifying the amended law to the output from the learning model to generate the determination result information is illustrated. The change necessity determination unit 15 may add the information with the input law.

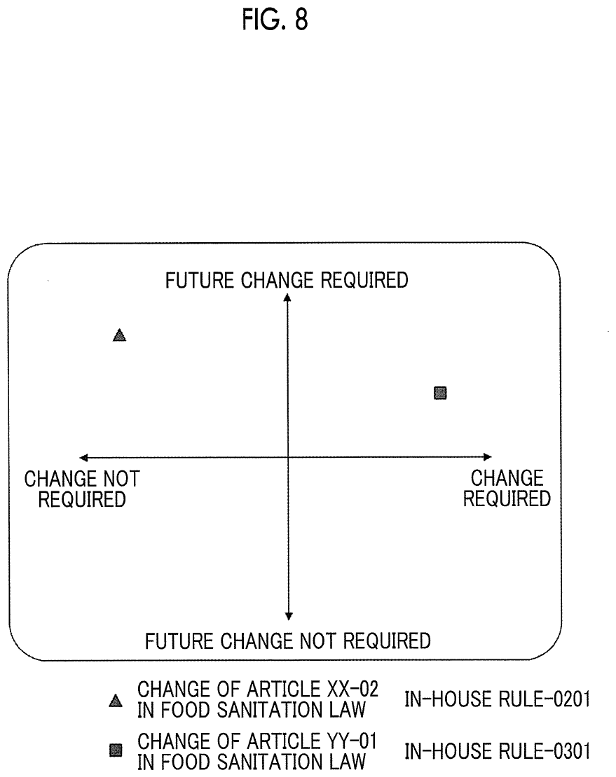

FIG. 8 is a diagram illustrating a display example in a case where the determination result information is displayed in a graph format in the exemplary embodiment. In the graph illustrated in FIG. 8, the necessity of change may be associated with a horizontal direction of the drawing, and the necessity of the future change may be associated with a vertical direction of the drawing, and the determination result information illustrated in FIG. 7 may be represented in a graph format. FIG. 8 illustrates an example in which two pieces of information are selected from a list of the determination result information illustrated in FIG. 7 and are plotted. It is possible to intuitively know the extent of the influence of the law amendment by displaying the determination result information in the graph format.

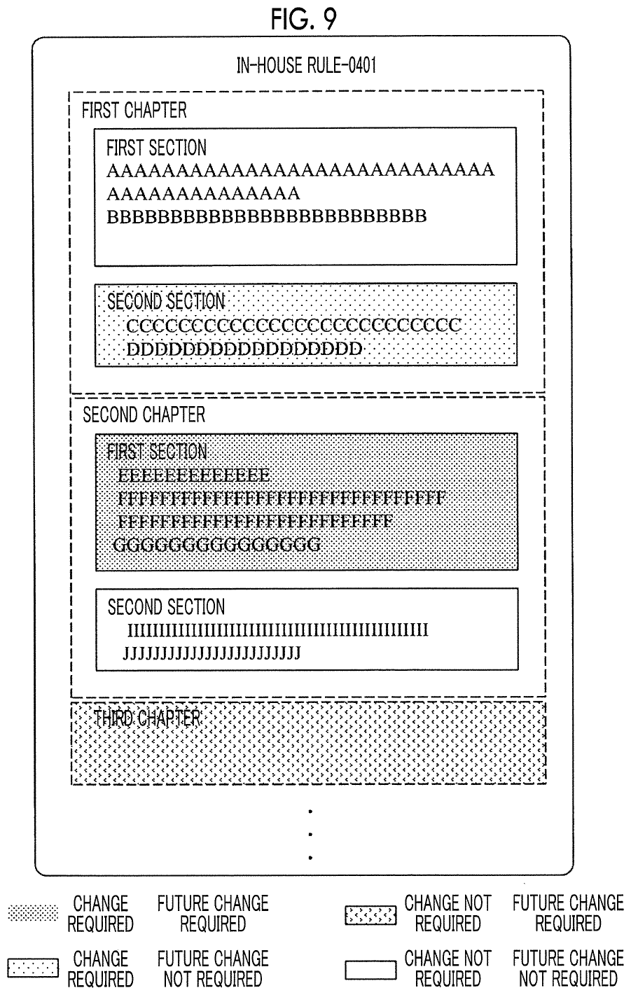

FIG. 9 is a diagram illustrating still another example of the data structure of the determination result information in the exemplary embodiment. Although FIG. 6 illustrates the example in which the range of determination of the necessity of the change is illustrated for each file, FIG. 9 illustrates an example in which the range of the determination is narrowed down to a partial description unit forming a chapter, a section, a paragraph, and the like by going deeper to the internal structure of a document file. In the exemplary embodiment, the difference in the determination result is expressed by adding a pattern in a frame surrounding the chapter or the paragraph, but the exemplary embodiment is not limited to this example. For example, the difference may be expressed by changing a display form such as a display color.

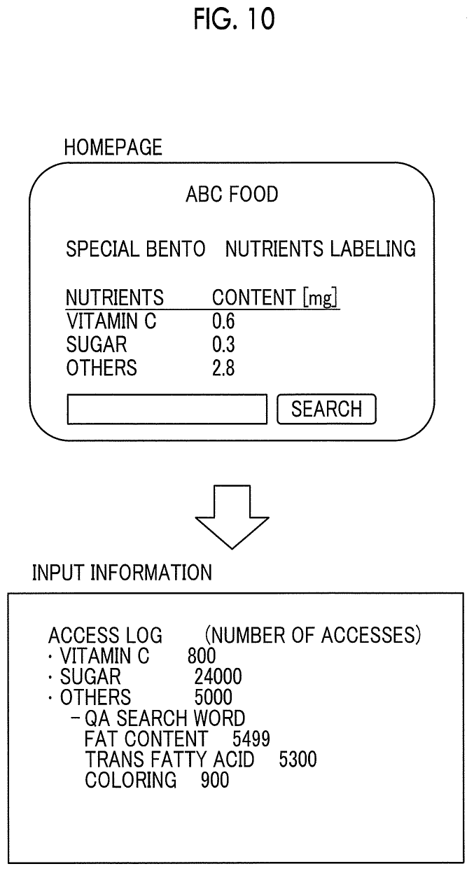

FIG. 10 is a diagram illustrating another example of the handled external information and the input information in the exemplary embodiment. Although FIG. 3 illustrates an example of referring to Twitter as the external information, FIG. 10 illustrates an example of referring to the access log to the homepage. FIG. 10 also illustrates an example of the input information generated from the access log of the homepage. FIG. 10 illustrates the number of accesses to phrases related to the labeling obligation in the Food Sanitation Law, but according to this numerical example, the number of accesses to vitamin C is 800 and relatively small. In other words, in a case where the learning model checks that vitamin C is not displayed in the in-house information, it is determined that the change of the in-house information is required for displaying vitamin C of which labeling is obligated due to the law amendment, at the current stage. In addition, it is determined that the interest of consumers is expected to be also low in the future from the input information, and it is determined that the future change of the in-house information is not required.

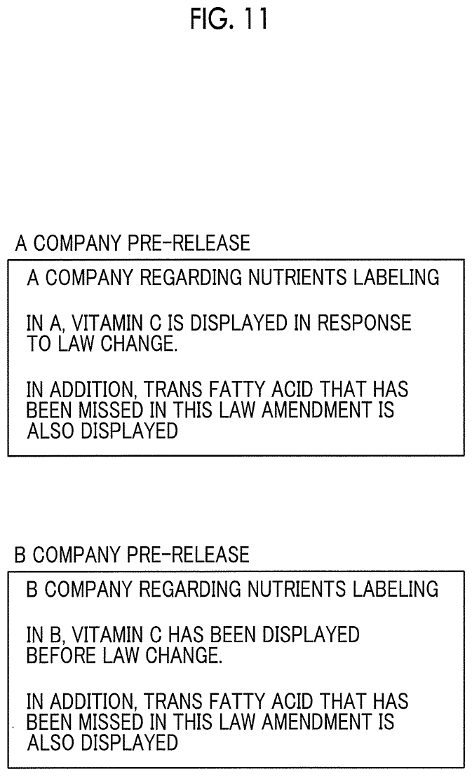

FIG. 11 is a diagram illustrating still another example of the external information handled in the exemplary embodiment. FIG. 11 illustrates the article of pre-release in other companies.

In the exemplary embodiment, the determination result is indicated for each range (file, chapter, section, or the like in the above example) as a candidate for the change, but the reason for obtaining the determination result may be provided to be included together in the determination result information. The reason is that, in addition to the above-described example, for example, the determination that the future change is required means that the number of accesses is expected to increase in the future although the number of accesses is small at the current time (that is, the interest of consumers is low). In addition, the determination that the measures for the future change are required means, for example, that other companies disclose information regarding components of the own product by referring to the pre-release in the other companies although the labeling is not obligated in the current time.

As described above, according to the exemplary embodiment, it is possible to determine whether or not the change of the in-house information in response to the law amendment is required, with reference to not only the law amendment information or information in the company, but also external information regarding the law amendment.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to
acquire an amendment point of a law,
acquire internal information of a group, which is influenced by amendment of the law,
acquire external information related to the amendment of the law from pieces of the external information provided outside the group, and
acquire determination result information regarding necessity of a change in response to the amendment of the law for each piece of the internal information by inputting the amendment point of the law, the internal information, and the acquired external information, to a learning model learned by a combination of the external information acquired in response to the previous amendment of the law and the internal information of the group, which has been changed in response to the previous amendment of the law.

2. The information processing apparatus according to claim 1,
wherein the processor is configured to perform a pre-process of processing the acquired external information into a format usable by the learning model and input the external information after the pre-process to the learning model.

3. The information processing apparatus according to claim 2,
wherein the external information includes at least one of a post to a social networking service, an access log, information provided by a company, a law in another country, or electronic data of a publication.

4. The information processing apparatus according to claim 1,
wherein the determination result information corresponding to the internal information required to be changed in response to the amendment of the law includes a range of the change.

5. The information processing apparatus according to claim 4,
wherein the range of the change is expressed by a part of a description that forms a file or a document.

6. The information processing apparatus according to claim 1,
wherein the determination result information includes necessity of a future change in response to the amendment of the law.

7. The information processing apparatus according to claim 6,
wherein the necessity of the future change in response to the amendment of the law is determined with reference to the acquired external information.

8. The information processing apparatus according to claim 1,
wherein the processor is configured to present, to a user, a combination of the amended law, information for identifying the internal information, and the determination result information corresponding to the internal information.

9. A non-transitory computer readable medium storing a program causing a computer to implement:
a function of acquiring an amendment point of a law;
a function of acquiring internal information of a group, which is influenced by amendment of the law;
a function of acquiring external information related to the amendment of the law from pieces of the external information provided outside the group; and
a function of acquiring determination result information regarding necessity of a change in response to the amendment of the law for each piece of the internal information by inputting the amendment point of the law, the internal information, and the acquired external information, to a learning model learned by a combination of the external information acquired in response to the previous amendment of the law and the internal information of the group, which has been changed in response to the previous amendment of the law.
